(19) United States
(12) Patent Application Publication
(10) Pub. No.: US 2026/0200021 A1
(43) Pub. Date: Jul. 16, 2026

(54) METHOD OF JOINING A CAST IRON COMPONENT WITH A STEEL COMPONENT AND ASSEMBLY PRODUCED THEREFROM

(71) Applicant: GM GLOBAL TECHNOLOGY OPERATIONS LLC, Detroit, MI (US)

(72) Inventors: Peng Shen, Troy, MI (US); Wenying Yang, Rochester Hills, MI (US); Cheonjae Bahk, Rochester, MI (US)

(73) Assignee: GM GLOBAL TECHNOLOGY OPERATIONS LLC, Detroit, MI (US)

(21) Appl. No.: 19/021,724

(22) Filed: Jan. 15, 2025

(51) Int. Cl. B23P 15/14; B22D 19/04; B23K 26/21

(52) U.S. Cl. CPC B23P 15/14; B22D 19/04; B23K 26/21

(57) ABSTRACT

A method of joining a cast iron first component with a steel second component without use of a filler material includes positioning a low carbon steel insert within a cavity of a mold, filling the cavity with cast iron wherein the molten cast iron is disposed in contact with the insert, cooling the molten cast iron to form the first component with the insert bonded to the first component to form a first assemblage, placing the second component in contact with the insert, and focusing a localized melting energy at a contact point between the second component and the insert so as to locally melt the second component and the insert at the contact point to form a weld nugget thereat, wherein the weld nugget bonds together the second component and the insert. An assembly produced by the method is also presented.

### INTRODUCTION

This disclosure relates generally to methods of joining cast iron components with steel components, and assemblies produced from such methods.

In the design and manufacture of various products, it is sometimes desirable to produce certain components out of one metal and to produce other components out of another metal. For example, in the production of differential systems for use in the powertrain of automotive vehicles, the differential carrier may be made out of cast iron and the ring gear may be made out of steel.

However, the high carbon content of cast iron can make such parts very difficult to weld to steel parts, which often necessitates the use of multiple fasteners between cast iron carrier and steel ring gears. Alternatively, nickel-based (or other) filler materials may be used between a cast iron part and a mating steel part in order to facilitate welding the parts together.

### SUMMARY

The present disclosure presents a method and resulting assembly which overcomes the difficulty of welding together cast iron parts and steel parts, but without the need for any filler material.

According to one embodiment, a method of joining a ductile cast iron first component with a steel second component is presented. The method includes: (i) positioning a low carbon steel insert within a cavity of a mold; (ii) filling the cavity with molten cast iron, wherein the molten cast iron is disposed in contact with the insert; (iii) cooling the molten cast iron to form the first component, wherein the insert is bonded to the first component to form a first assemblage; (iv) placing the second component in contact with the insert; and (v) focusing a localized melting energy at a contact point between the second component and the insert so as to locally melt the second component and the insert at the contact point to form a weld nugget thereat, wherein the weld nugget bonds together the second component and the insert.

The forming of the weld nugget may be accomplished without use of a filler material between the second component and the insert that is different from the low carbon steel of the insert and the steel of the second component.

After cooling the molten cast iron and before placing the steel second component in contact with the insert, the method may further include removing the first assemblage from the mold.

The localized melting energy may include a laser welding beam.

In the positioning of the low carbon steel insert within the cavity, the insert may be positioned against an inner mold surface within the cavity.

The first component may be a differential carrier and the second component may be a ring gear.

The first component may have a carbon content that is sufficiently high enough to make the first component substantially unweldable. Additionally, the carbon content of the low carbon steel insert may be sufficiently low enough to make the insert substantially weldable to the steel second component.

The insert and the first component may have respective and complementary geometric features which keep the insert in contact with the first component and constrain the insert against movement with respect to the first component.

In the first assemblage, the insert may have a first insert surface in contact with the first component, the insert further having one or both of (i) one or more raised surface features extending outward from the first insert surface and (ii) one or more lowered surface features extending inward from the first insert surface. Each of the raised surface features may be shaped as one or more of a protuberance, a spiral thread and a spline, and each of the lowered surface features may be shaped as one or more of a concavity, a spiral thread and a furrow.

According to another embodiment, a method of joining a first component made of ductile cast iron with a second component made of steel is presented. The method includes: (i) providing a mold having a cavity therein; (ii) positioning an insert made of low carbon steel against an inner mold surface within the cavity; (iii) filling the cavity with molten cast iron, wherein the molten cast iron is disposed in contact with the insert; (iv) cooling the molten cast iron to form the first component, wherein the insert is bonded to the first component to form a first assemblage; (v) removing the first assemblage from the mold; (vi) placing the second component in contact with the insert; and (vii) focusing a laser welding beam at a contact point between the second component and the insert so as to locally melt the second component and the insert at the contact point to form a weld nugget thereat without use of a filler material therebetween, wherein the weld nugget bonds together the second component and the insert.

The ductile cast iron first component may be a differential carrier and the steel second component may be a ring gear.

The first component may have a carbon content that is sufficiently high enough to make the first component substantially unweldable, and the carbon content of the low carbon steel insert may be sufficiently low enough to make the insert substantially weldable to the steel second component.

The insert and the first component may have respective geometric features that are complementary with each other and which keep the insert in contact with the first component and constrain the insert against translation and rotation with respect to the first component.

In the first assemblage, the insert may have a first insert surface in contact with the first component, the insert further having one or both of: (i) one or more raised surface features extending outward from the first insert surface, wherein each of the raised surface features is shaped as one or more of a protuberance, a spiral thread and a spline; and (ii) one or more lowered surface features extending inward from the first insert surface, wherein each of the lowered surface features is shaped as one or more of a concavity, a spiral thread and a furrow.

According to yet another embodiment, an assembly includes: (i) a first component made of ductile cast iron; (ii) an insert made of low carbon steel and having a first insert surface in contact with the first component, wherein the insert and the first component have respective and complementary geometric features which keep the insert in contact with the first component and constrain the insert against movement with respect to the first component; and (iii) a second component made of steel and disposed in contact with a second insert surface of the insert. Here, the second component is bonded to the insert by a weld nugget located at a contact point between the second component and the insert, wherein the weld nugget is composed of low carbon steel from the insert and steel from the second component that have been locally melted and solidified to form the weld nugget without use of a filler material therebetween.

The insert may include one or both of: (i) one or more raised surface features extending outward from the first insert surface; and (ii) one or more lowered surface features extending inward from the first insert surface.

The first component may be a differential carrier and the second component may be a ring gear. The differential carrier and the ring gear may be operatively connected with each other to form a differential carrier assembly arrangement, with the assembly further including an automotive vehicle having a powertrain, wherein the powertrain includes the differential carrier assembly arrangement.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic cross-sectional side view of a mold having a cavity therein.

FIG. 2 is the same view as shown in FIG. 1 but with a low carbon steel insert positioned in the cavity.

FIG. 3 is a block diagram of raised and lowered surface features extending outward and inward, respectively, from a first insert surface of the insert.

FIG. 4 is the same view as shown in FIG. 2 but with the mold cavity filled with molten cast iron.

FIG. 5 is the same view as shown in FIG. 4 but with the cast iron being solidified to form a first component, and with the insert and the first component defining a first assemblage.

FIG. 6 is a schematic cross-sectional close-up side view of a portion of the first assemblage shown in FIG. 5 but with the first assemblage rotated 90 degrees counter-clockwise and with a steel second component positioned in contact with the insert.

FIG. 7 is a schematic side view of the first assemblage and second component shown in FIG. 6 but viewed along section line A-A.

FIG. 8 is the same view as shown in FIG. 6 but with a beam of localized melting energy directed at a contact point between the insert and the second component.

FIG. 9 is the same view as shown in FIG. 8 but with a weld nugget formed at the contact point.

FIG. 10 is a block diagram of an assembly which may be produced by the process steps illustrated by FIGS. 1-9.

FIG. 11 is a flowchart for a method of joining a cast iron first component with a steel second component to form the assembly of FIG. 10.

### DETAILED DESCRIPTION

Referring now to the drawings, wherein like numerals indicate like parts in the several views, a method 100 of joining a cast iron first component 30 with a steel second component 70, and an assembly 90 produced from the method 100, are shown and described herein.

As noted above, it is very difficult to weld parts that are made out of cast iron. This is true at least in part because of the relatively high hardness and high carbon content of cast iron parts, as contrasted with steel parts which have relatively lower hardness and lower carbon content as compared to cast iron parts, which makes steel parts much easier to weld. However, the method 100 and assembly 90 of the present disclosure provide a way that enables a cast iron part to be indirectly bonded or welded to a steel part, through the use of a low carbon steel insert 40 placed between the cast iron part and the steel part, along with a localized melting of the low carbon steel of the insert 40 and the steel of the steel part without the use of any filler material therebetween, as described in more detail below.

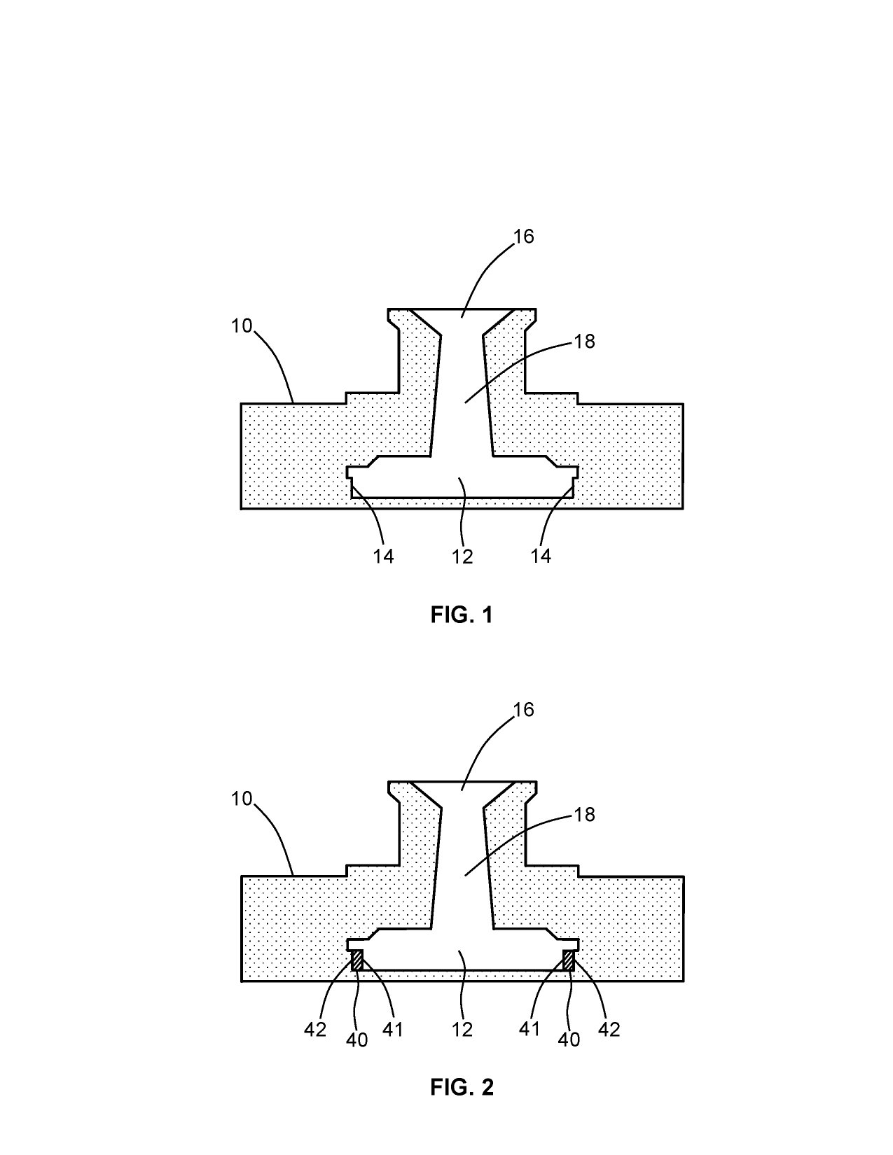

FIG. 1 shows a mold 10 having a cavity 12 therein. The mold 10 may be made of any material suitable for forming castings from molten metal, such as sand or loam. Note that the mold 10 includes a gate 16 and a sprue 18 through which molten metal may be poured into the cavity 12.

FIG. 2 shows the same view as FIG. 1, but with a low carbon steel insert 40 positioned within the cavity 12. Here, the insert 40 is placed against an inner mold surface 14 within the cavity 12 of the mold 10. In some configurations, the insert 40 may take the form of a single cylindrical sleeve having a first or inner insert surface 41 and a second or outer insert surface 42, while in other configurations the insert 40 may take the form of a plurality of individual curved or straight plates with each insert 40 having a respective first/inner insert surface 41 and a respective outer/second insert surface 42.

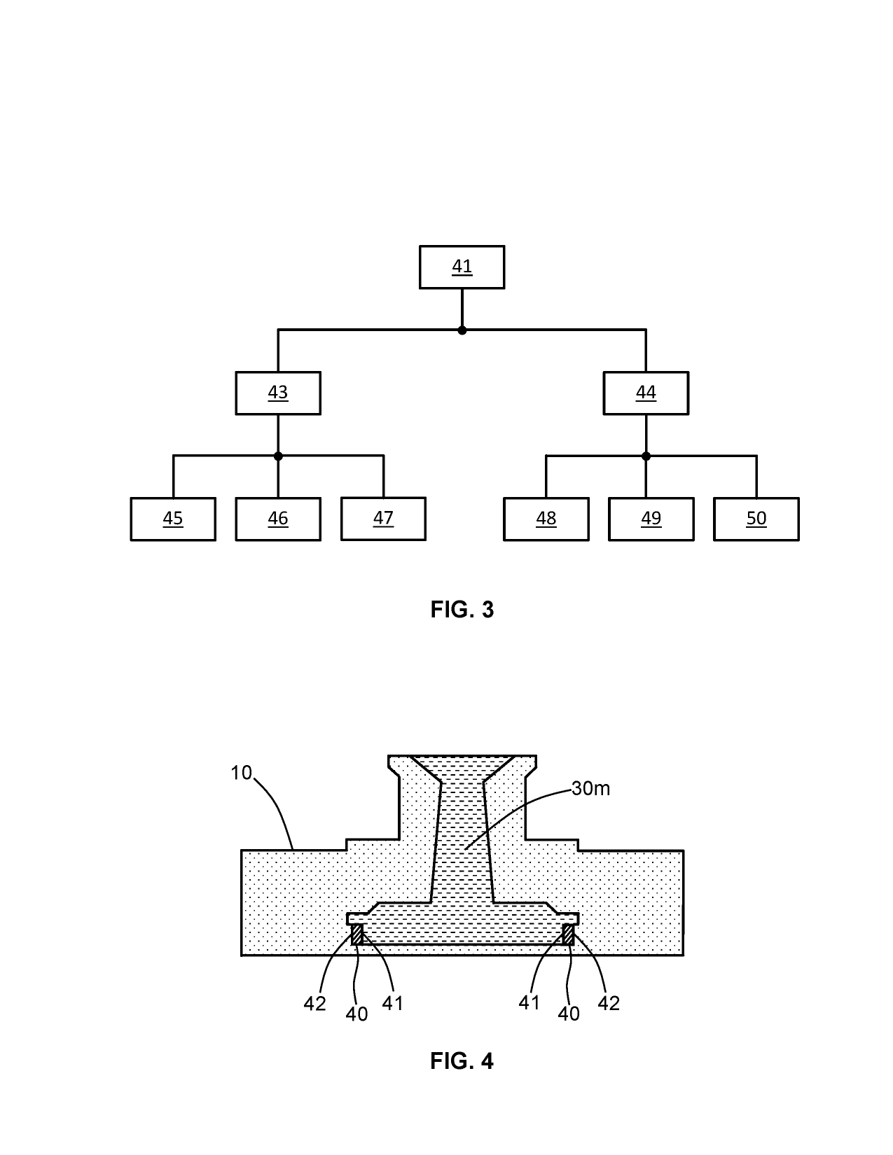

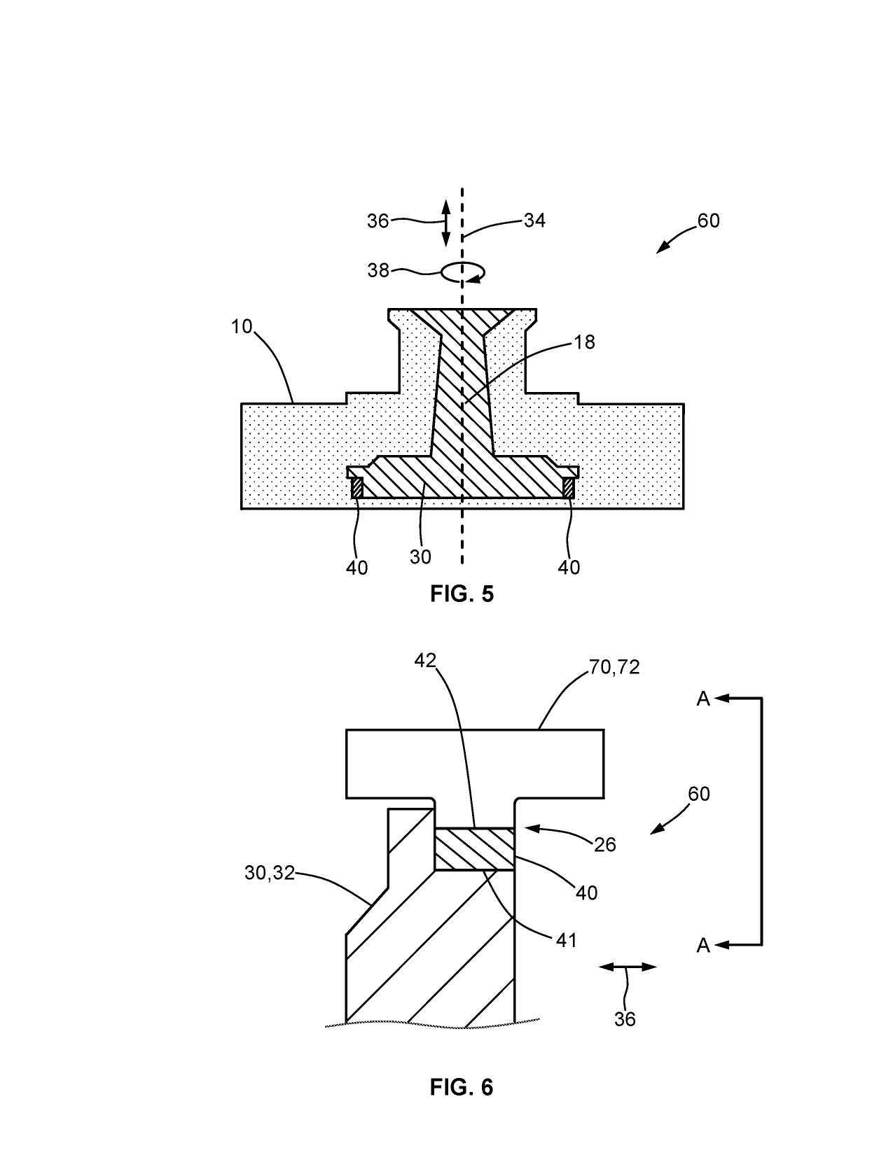

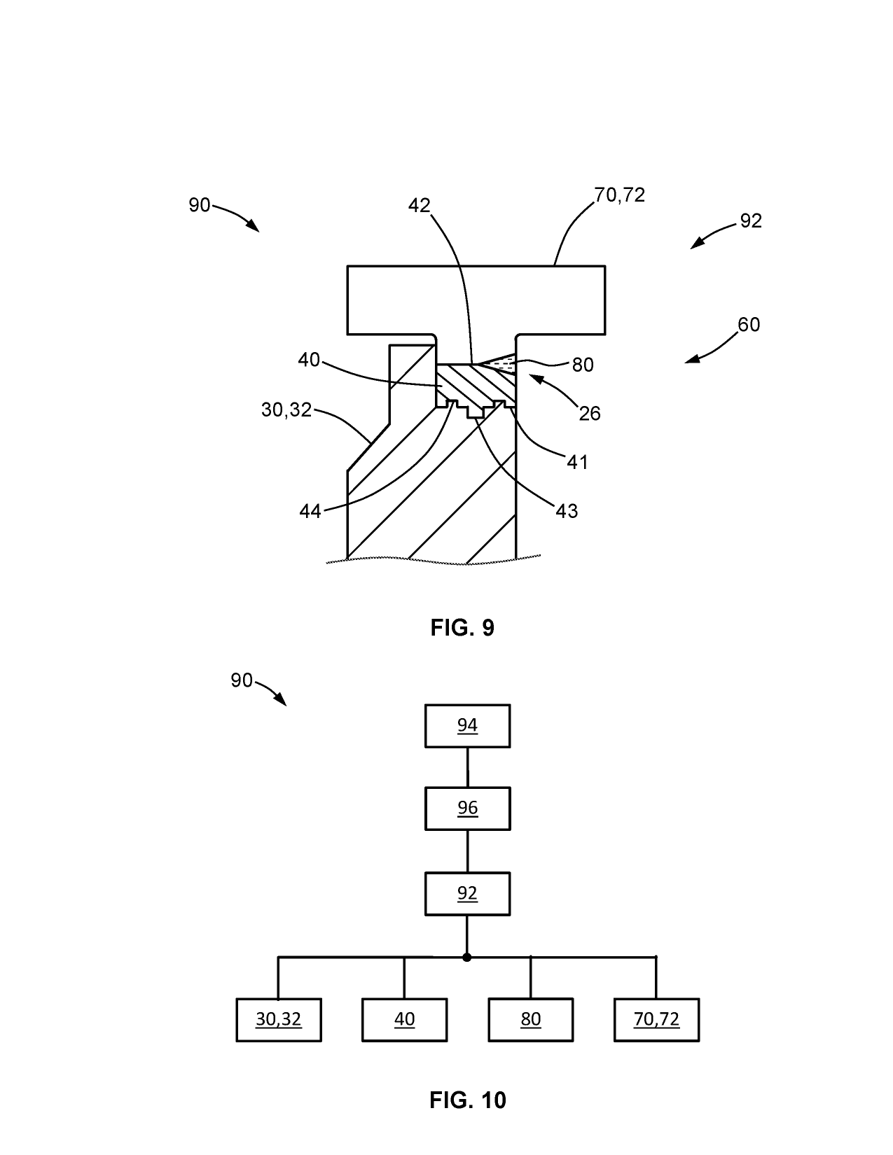

FIG. 3 shows a block diagram of various types of raised surface features 43 that may extend outward from the first insert surface 41 of the insert 40, as well as various types of lowered surface features 44 that may extend inward from the first insert surface 41. For example, the raised surface features 43 may include one or more of a protuberance 45 (e.g., a bump or stud), a spiral thread 46 (e.g., similar to screw/bolt threads, but proud or raised up from the first insert surface 41) and a spline 47 (e.g., a straight, curved or zig-zagged ridge), and the lowered surface features may include one or more of a concavity 48 (e.g., a dimple or depression), a spiral thread 49 (e.g., similar to screw/bolt threads, but sunk into the first insert surface 41) and a furrow 50 (e.g., a straight, curved or zig-zagged trough). The respective first/inner insert surface 41 of each insert 40 may include one or more raised surface features 43, one or more lowered surface features 44, or some combination of raised and lowered surface features 43, 44. The purpose of these surface features 43, 44 is discussed below in connection with FIGS. 5 and 9.

FIG. 4 shows the same view as FIG. 2, but with the mold cavity 12 being filled with molten cast iron 30m. For example, the molten iron 30m may be poured into the gate 16, and the molten iron 30m will flow through the sprue 18 and into the cavity 12. Although not shown, the mold 10 may also include risers and vents to allow gases to escape when the molten iron 30m is poured into the cavity 12. Note that the molten cast iron 30m fills the cavity 12 and makes intimate contact with the insert 40 that was positioned in the cavity 12.

FIG. 5 shows the same view as shown in FIG. 4, but with the formerly molten cast iron 30m now being cooled and solidified to form a first component 30, and with the insert 40 and the first component 30 together defining a first assemblage 60. The first component 30 may have an axis of rotation 34 which defines a translational direction 36 along the axis 34 and a rotational direction 38 about the axis 34. Although not explicitly shown in FIG. 5, the abovementioned raised and lowered surface features 43, 44 may be included on the first/inner insert surface 41 (as shown in FIG. 9) to help each insert 40 to become bonded to the first component 30 as the molten cast iron 30m is cooled.

FIG. 6 shows a close-up side view of the first assemblage 60 shown in FIG. 5, but with the first assemblage 60 rotated 90 degrees counter-clockwise and with a steel second component 70 positioned in intimate contact with the insert 40. Note that the first/inner insert surface 41 of the insert 40 interfaces with (i.e., is in intimate mechanical or tactile contact with) the first component 30, while the second/outer insert surface 42 of the insert 40 interfaces with the second component 70.

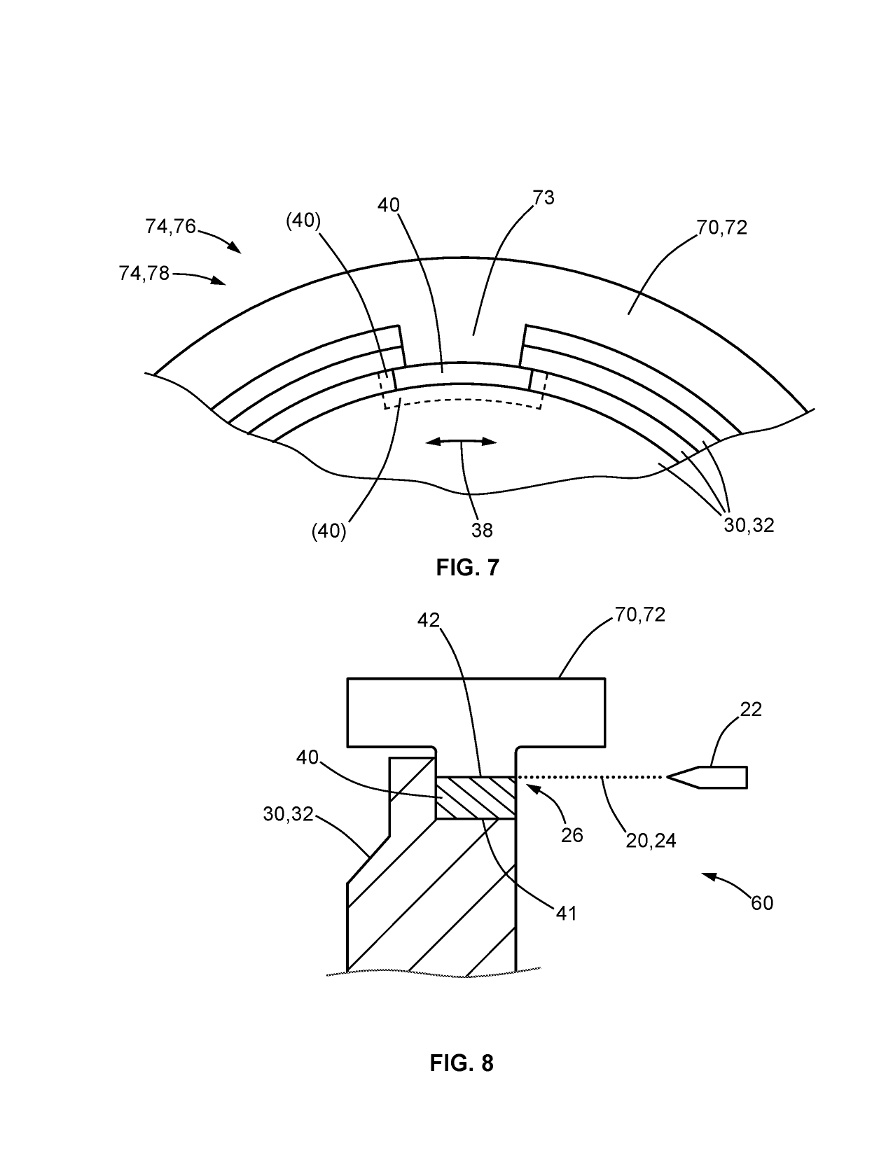

FIG. 7 shows a schematic side view of the first assemblage 60 and second component 70 shown in FIG. 6, but viewed along section line A-A of FIG. 6. As illustrated here, the first component 30 may be formed as a differential carrier 32, and the second component 70 may be formed as a ring gear 72. Note that the second component/ring gear 70, 72 may include a plurality of radial arms 73, although only one is shown in the partial view of FIG. 7. Each radial arm 73 may be in mechanical contact with a respective one of multiple inserts 40; or, if only one insert 40 is used for the entire first assemblage 60 (e.g., with the singular insert 40 shaped as a ring or annulus), then each of the multiple radial arms 73 may be in mechanical contact with the single insert 40.

As illustrated in FIG. 7, the insert 40 and the first component 30 may have respective and complementary geometric features 74 which keep the insert 40 in contact with the first component 30 and constrain the insert 40 against movement (such as translation 36 and/or rotation 38) with respect to the first component 30. In other words, the insert 40 may have one or more insert geometric features 76 and the first component 30 may have one or more first component geometric features 78, with these features 76, 78 being sized, shaped and oriented such that they fit, interlock or act together to keep the insert 40 attached to and/or captured by the first component 30. (Note that as used herein, reference numeral 74 may refer to any or all types of geometric features as between the insert 40 and the first component 30, while reference numeral 76 refers to geometric features of the insert 40 and reference numeral 78 refers to geometric features of the first component 30.)

For example, the first component 30 may be a generally disc-shaped differential carrier 32 with a circumferential surface or shoulder thereabout, and the insert 40 may take the form of a single cylindrical sleeve or of multiple individual inserts 40 each having an arcuate shape, wherein the inner surface(s) of the insert(s) 40 snugly fit around and onto the circumferential surface/shoulder of the first component/carrier 30, 32. In this arrangement, the size and circular/cylindrical shape of the circumferential surface/shoulder would be considered as first component geometric features 78, and the size and circular/cylindrical shape of the sleeve/insert 40 (and, in particular, of the sleeve’s or insert’s inner surface) would be insert geometric features 76, and these respective geometric features 76, 78 would be respectively sized, shaped and oriented with respect to each other such that essentially an interference fit is presented between the circumferential surface/shoulder of the disc-shaped first component/carrier 30, 32 and the inner surface of the sleeve/insert 40.

As another example, the insert 40 and/or the first component 30 may have respective tabs, shoulders, surfaces and/or other geometric features 76, 78 which allow the first component 30 to “capture” or retain the insert 40, so that it is constrained against movement with respect to the first component 30. For example, in FIG. 7, it can be seen by the dashed lines that certain portions of the insert 40 are overlapped by the first component/carrier 30, 32 (as denoted by portions of the insert 40 with reference numeral 40 in parentheses), thus allowing the first component/carrier 30, 32 to capture the insert 40 and restrain it against translation 36 and rotation 38.

FIG. 8 shows the same view as shown in FIG. 6, but with a beam 24 of localized melting energy 20 directed at a contact point 26 that is located between the insert 40 and the second component 70. For example, the localized melting energy 20 may take the form of a laser welder 22 which produces a laser beam 24 and operates at a frequency and power level that is effective for locally melting the low carbon steel of the insert 40 and the steel of the second component 70 at the contact point 26 (i.e., at a location where the insert 40 and the second component 70 are in contact with each other and where the beam 24 impinges on the insert 40 and the second component 70).

FIG. 9 shows the same view as shown in FIG. 8, but with a weld nugget 80 formed at the contact point 26. This weld nugget 80 is made of the low carbon steel of the insert 40 and the steel of the second component 70, and is formed from these materials being melted by the localized melting energy 20 or laser welder 22 and then being allowed or forced to cool and solidify.

In some cases, the weld nugget 80 may take the form of a single continuous weld seam which extends around the entire circumference, periphery or perimeter of the insert/second component interface, while in other cases the weld nugget 80 may take the form of multiple weld seams or spot welds that are separated from each other and which together span the entire circumference, periphery or perimeter of the insert/second component interface. For example, if the first component 30 is a cast iron differential carrier 32 having an outer circumferential surface or shoulder, the insert 40 is a low carbon steel cylindrical sleeve having a first/inner insert surface 41 that snugly fits around and onto the outer circumferential shoulder (such that the insert/sleeve 40 is captured or restrained against movement with respect to the carrier 32), and the second component 70 is a steel ring gear 72 that snugly fits around and onto the second/outer insert surface 42 of the insert/sleeve 40, then the weld nugget 80 may be implemented as a single, continuous, circular-shaped weld seam which extends 360 degrees around the rotational axis of the carrier/sleeve/ring gear assembly; alternatively, the weld nugget 80 may be implemented as a series of spot welds or weld seams that are evenly spaced around the rotational axis.

As noted above, FIG. 9 also shows examples of the aforementioned raised and lowered surface features 43, 44 on the first/inner insert surface 41 of the insert 40. For example, two raised surface features 43 and one lowered surface feature 44 are shown. Since these features 43, 44 are shown here in cross-sectional view, each of the two raised surface features 43 may be a protuberance 45, a raised spiral thread 46, a spline 47, or the like, and the lowered surface feature 44 may be a concavity 48, a lowered spiral thread 49, a furrow 50, etc.

FIG. 10 shows a block diagram of an assembly 90 which may be produced by the process steps illustrated by FIGS. 1-9. The assembly 90 includes a first component 30 made of ductile cast iron that is bonded with (i.e., joined with or attached to) a second component 70 made of steel, by utilizing a low carbon steel insert 40 that has been embedded into or captured by the first component 30 as a result of the molding process, and that has been attached to the second component 70 as a result of the localized melting/laser welding process.

As illustrated in FIG. 10, the resulting assembly 90 includes a first component 30 made of ductile cast iron, an insert 40 made of low carbon steel and having a first insert surface 41 disposed in contact with the first component 30, and a second component 70 made of steel and disposed in contact with a second insert surface 42 of the insert 40. Here, the second component 70 is bonded to the insert 40 by a weld nugget 80 located at a contact point 26 between the second component 70 and the insert 40, with the weld nugget 80 being composed of low carbon steel from the insert 40 and steel from the second component 70 that have been locally melted and solidified to form the weld nugget 80 without the use of any filler material therebetween.

In this arrangement, the cast iron first component 30 may have a hardness and/or a carbon content that is sufficiently high enough to make the first component 30 substantially unweldable. Additionally, the hardness and/or carbon content of the low carbon steel insert 40 may be sufficiently low enough to make the insert 40 substantially weldable, such as to the steel second component 70 which also may have a relatively low hardness and/or carbon content.

The assembly 90 and method 100 may be implemented to form a variety of products that call for a component made of ductile cast iron to be attached to another component made of steel. For example, the first component 30 may be a differential carrier 32 made of cast iron and the second component 70 may be a ring gear 72 made of steel. As illustrated in FIG. 10, the differential carrier 32 and the ring gear 72 may be operatively connected with each other via the insert 40 and weld nugget 80 to form a differential carrier assembly arrangement 92, with the assembly 90 further including an automotive vehicle 94 having a powertrain 96, wherein the powertrain 96 includes the differential carrier assembly arrangement 92.

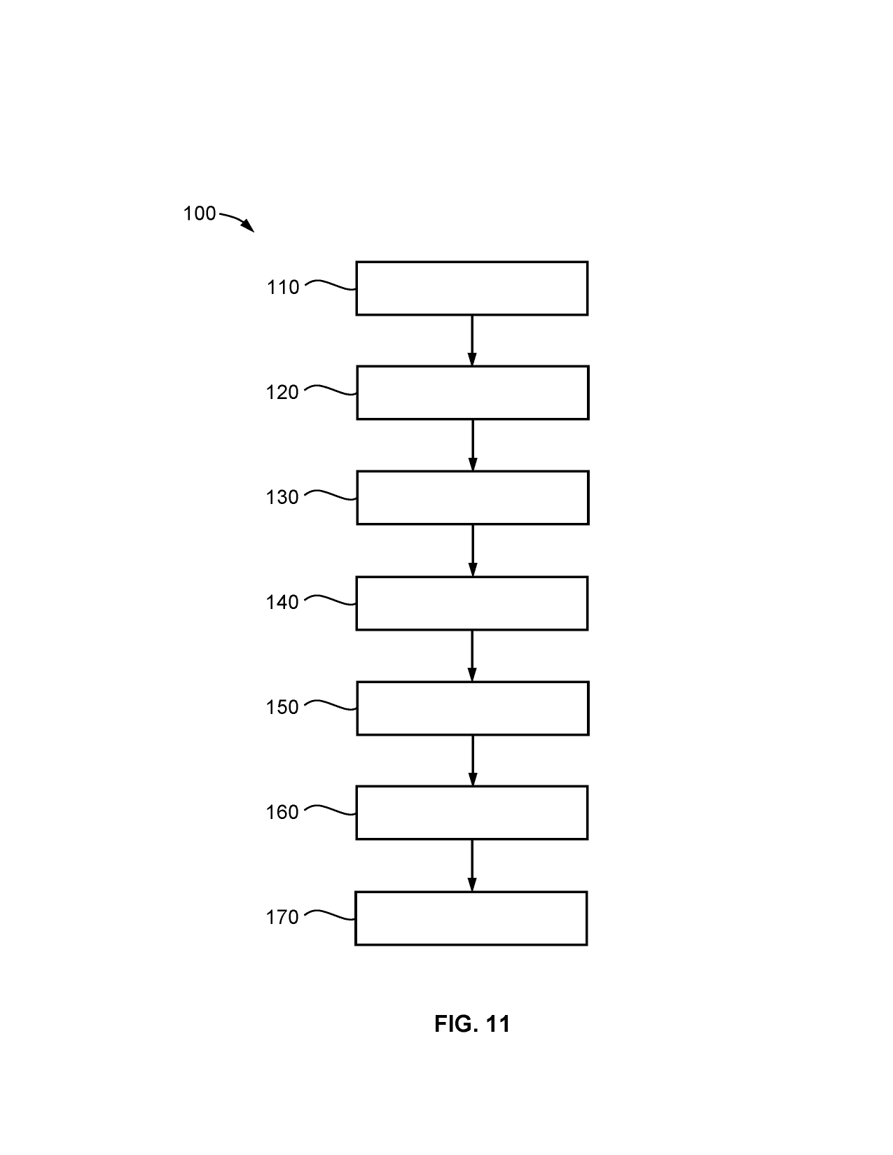

FIG. 11 shows a flowchart for a method 100 of joining a cast iron first component 30 with a steel second component 70 to produce the abovementioned assembly 90. At block 110 of the flowchart, a mold 10 having a cavity 12 therein is provided, and at block 120 an insert 40 made of low carbon steel is positioned against an inner mold surface 14 within the cavity 12. At block 130, the cavity 12 is filled with molten cast iron 30m, such that the molten cast iron 30m is disposed in contact with the insert 40. At block 140, the molten cast iron 30m is cooled to form the first component 30, which causes the insert 40 to be bonded to the first component 30 to form a first assemblage 60. At block 150, the first assemblage 60 is removed from the mold 10, and at block 160 the second component 70 is placed in contact with the insert 40. At block 170, a localized melting energy 20 or laser welding beam 24 is focused at a contact point 26 between the second component 70 and the insert 40 so as to locally melt the second component 70 and the insert 40 at the contact point 26 to form a weld nugget 80 thereat without use of a filler material therebetween, with the weld nugget 80 bonding together the second component 70 and the insert 40.

As one having skill in the relevant art will appreciate, the method 100 and assembly 90 of the present disclosure may be presented or arranged in a variety of different configurations and embodiments.

According to one embodiment, a method 100 of joining a ductile cast iron first component 30 with a steel second component 70 is presented. The method 100 includes: (i) at block 120, positioning a low carbon steel insert 40 within a cavity 12 of a mold 10; (ii) at block 130, filling the cavity 12 with molten cast iron 30m, wherein the molten cast iron 30m is disposed in contact with the insert 40; (iii) at block 140, cooling the molten cast iron 30m to form the first component 30, wherein the insert 40 is bonded to the first component 30 to form a first assemblage 60; (iv) at block 160, placing the second component 70 in contact with the insert 40; and (vii) at block 170, focusing a localized melting energy 20 at a contact point 26 between the second component 70 and the insert 40 so as to locally melt the second component 70 and the insert 40 at the contact point 26 to form a weld nugget 80 thereat, wherein the weld nugget 80 bonds together the second component 70 and the insert 40.

The forming of the weld nugget 80 may be accomplished without use of a filler material between the second component 70 and the insert 40 that is different from the low carbon steel of the insert 40 and the steel of the second component 70.

After cooling the molten cast iron 30m and before placing the steel second component 70 in contact with the insert 40, the method 100 may further include, at block 150, removing the first assemblage 60 from the mold 10.

The localized melting energy 20 may include a laser welding beam 24.

In the positioning of the low carbon steel insert 40 within the cavity 12, the insert 40 may be positioned against an inner mold surface 14 within the cavity 12.

The first component 30 may be a differential carrier 32 and the second component 70 may be a ring gear 72.

The first component 30 may have a carbon content that is sufficiently high enough to make the first component 30 substantially unweldable. Additionally, the carbon content of the low carbon steel insert 40 may be sufficiently low enough to make the insert 40 substantially weldable to the steel second component 70.

The insert 40 and the first component 30 may have respective and complementary geometric features 76, 78 which keep the insert 40 in contact with the first component 30 and constrain the insert 40 against movement with respect to the first component 30.

In the first assemblage 60, the insert 40 may have a first insert surface 41 in contact with the first component 30, the insert 40 further having one or both of (i) one or more raised surface features 43 extending outward from the first insert surface 41 and (ii) one or more lowered surface features 44 extending inward from the first insert surface 41. Each of the raised surface features 43 may be shaped as one or more of a protuberance 45, a spiral thread 46 and a spline 47, and each of the lowered surface features 44 may be shaped as one or more of a concavity 48, a spiral thread 49 and a furrow 50.

According to another embodiment, a method 100 of joining a first component 30 made of ductile cast iron with a second component 70 made of steel is presented. The method 100 includes: (i) at block 110, providing a mold 10 having a cavity 12 therein; (ii) at block 120, positioning an insert 40 made of low carbon steel against an inner mold surface 14 within the cavity 12; (iii) at block 130, filling the cavity 12 with molten cast iron 30m, wherein the molten cast iron 30m is disposed in contact with the insert 40; (iv) at block 140, cooling the molten cast iron 30m to form the first component 30, wherein the insert 40 is bonded to the first component 30 to form a first assemblage 60; (v) at block 150, removing the first assemblage 60 from the mold 10; (vi) at block 160, placing the second component 70 in contact with the insert 40; and (x) at block 170, focusing a laser welding beam 24 at a contact point 26 between the second component 70 and the insert 40 so as to locally melt the second component 70 and the insert 40 at the contact point 26 to form a weld nugget 80 thereat without use of a filler material therebetween, wherein the weld nugget 80 bonds together the second component 70 and the insert 40.

The ductile cast iron first component 30 may be a differential carrier 32 and the steel second component 70 may be a ring gear 72.

The first component 30 may have a carbon content that is sufficiently high enough to make the first component 30 substantially unweldable, and the carbon content of the low carbon steel insert 40 may be sufficiently low enough to make the insert 40 substantially weldable to the steel second component 70.

The insert 40 and the first component 30 may have respective geometric features 76, 78 that are complementary with each other and which keep the insert 40 in contact with the first component 30 and constrain the insert 40 against translation 36 and rotation 38 with respect to the first component 30.

In the first assemblage 60, the insert 40 may have a first insert surface 41 in contact with the first component 30, the insert 40 further having one or both of: (i) one or more raised surface features 43 extending outward from the first insert surface 41, wherein each of the raised surface features 43 is shaped as one or more of a protuberance 45, a spiral thread 46 and a spline 47; and (ii) one or more lowered surface features 44 extending inward from the first insert surface 41, wherein each of the lowered surface features 44 is shaped as one or more of a concavity 48, a spiral thread 49 and a furrow 50.

According to yet another embodiment, an assembly 90 includes: (i) a first component 30 made of ductile cast iron; (ii) an insert 40 made of low carbon steel and having a first insert surface 41 in contact with the first component 30, wherein the insert 40 and the first component 30 have respective and complementary geometric features 76, 78 which keep the insert 40 in contact with the first component 30 and constrain the insert 40 against movement with respect to the first component 30; and (iii) a second component 70 made of steel and disposed in contact with a second insert surface 42 of the insert 40. Here, the second component 70 is bonded to the insert 40 by a weld nugget 80 located at a contact point 26 between the second component 70 and the insert 40, wherein the weld nugget 80 is composed of low carbon steel from the insert 40 and steel from the second component 70 that have been locally melted and solidified to form the weld nugget 80 without use of a filler material therebetween.

The insert 40 may include one or both of: (i) one or more raised surface features 43 extending outward from the first insert surface 41; and (ii) one or more lowered surface features 44 extending inward from the first insert surface 41.

The first component 30 may be a differential carrier 32 and the second component 70 may be a ring gear 72. The differential carrier 32 and the ring gear 72 may be operatively connected with each other to form a differential carrier assembly arrangement 92, with the assembly 90 further including an automotive vehicle 94 having a powertrain 96, wherein the powertrain 96 includes the differential carrier assembly arrangement 92.

While various steps of the method 100 have been described as being separate blocks, and various aspects of the assembly 90 have been described as being separate elements, it may be noted that two or more steps may be combined into fewer blocks, and two or more aspects may be combined into fewer elements. Similarly, some steps described as a single block may be separated into two or more blocks, and some aspects described as a single module or element may be separated into two or more elements. Additionally, the order of the steps or blocks described herein may be rearranged in one or more different orders, and the arrangement of the elements may be rearranged into one or more different arrangements.

Also note that at some points throughout the present disclosure, reference may be made to a singular input, output, element, etc., while at other points reference may be made to plural/multiple inputs, outputs, elements, etc. Thus, weight should not be given to whether the input(s), output(s), element(s), etc. are used in the singular or plural form at any particular point in the present disclosure, as the singular and plural uses of such words should be viewed as being interchangeable, unless the specific context dictates otherwise.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A method of joining a ductile cast iron first component with a steel second component, comprising:
positioning a low carbon steel insert within a cavity of a mold;
filling the cavity with molten cast iron, wherein the molten cast iron is disposed in contact with the insert;
cooling the molten cast iron to form the first component, wherein the insert is bonded to the first component to form a first assemblage;
placing the second component in contact with the insert; and
focusing a localized melting energy at a contact point between the second component and the insert so as to locally melt the second component and the insert at the contact point to form a weld nugget thereat, wherein the weld nugget bonds together the second component and the insert.

2. The method of claim 1, wherein the forming of the weld nugget is accomplished without use of a filler material between the second component and the insert that is different from the low carbon steel of the insert and the steel of the second component.

3. The method of claim 1, further comprising, after cooling the molten cast iron and before placing the steel second component in contact with the insert:
removing the first assemblage from the mold.

4. The method of claim 1, wherein the localized melting energy comprises a laser welding beam.

5. The method of claim 1, wherein in the positioning of the low carbon steel insert within the cavity, the insert is positioned against an inner mold surface within the cavity.

6. The method of claim 1, wherein the ductile cast iron first component is a differential carrier and the steel second component is a ring gear.

7. The method of claim 1, wherein the first component has a carbon content that is sufficiently high enough to make the first component substantially unweldable.

8. The method of claim 7, wherein the carbon content of the low carbon steel insert is sufficiently low enough to make the insert substantially weldable to the steel second component.

9. The method of claim 1, wherein the insert and the first component have respective and complementary geometric features which keep the insert in contact with the first component and constrain the insert against movement with respect to the first component.

10. The method of claim 1, wherein, in the first assemblage, the insert has a first insert surface in contact with the first component, the insert further having one or both of (i) one or more raised surface features extending outward from the first insert surface and (ii) one or more lowered surface features extending inward from the first insert surface.

11. The method of claim 10, wherein each of the raised surface features is shaped as one or more of a protuberance, a spiral thread and a spline, and wherein each of the lowered surface features is shaped as one or more of a concavity, a spiral thread and a furrow.

12. A method of joining a first component made of ductile cast iron with a second component made of steel, comprising:
providing a mold having a cavity therein;
positioning an insert made of low carbon steel against an inner mold surface within the cavity;
filling the cavity with molten cast iron, wherein the molten cast iron is disposed in contact with the insert;
cooling the molten cast iron to form the first component, wherein the insert is bonded to the first component to form a first assemblage;
removing the first assemblage from the mold;
placing the second component in contact with the insert; and
focusing a laser welding beam at a contact point between the second component and the insert so as to locally melt the second component and the insert at the contact point to form a weld nugget thereat without use of a filler material therebetween, wherein the weld nugget bonds together the second component and the insert.

13. The method of claim 12, wherein the first component is a differential carrier and the second component is a ring gear.

14. The method of claim 12, wherein the first component has a carbon content that is sufficiently high enough to make the first component substantially unweldable, and wherein the carbon content of the low carbon steel insert is sufficiently low enough to make the insert substantially weldable to the steel second component.

15. The method of claim 12, wherein the insert and the first component have respective geometric features that are complementary with each other and which keep the insert in contact with the first component and constrain the insert against translation and rotation with respect to the first component.

16. The method of claim 12, wherein, in the first assemblage, the insert has a first insert surface in contact with the first component, the insert further having one or both of:
one or more raised surface features extending outward from the first insert surface, wherein each of the raised surface features is shaped as one or more of a protuberance, a spiral thread and a spline; and
one or more lowered surface features extending inward from the first insert surface, wherein each of the lowered surface features is shaped as one or more of a concavity, a spiral thread and a furrow.

17. An assembly, comprising:
a first component made of ductile cast iron;
an insert made of low carbon steel and having a first insert surface in contact with the first component, wherein the insert and the first component have respective and complementary geometric features which keep the insert in contact with the first component and constrain the insert against movement with respect to the first component; and
a second component made of steel and disposed in contact with a second insert surface of the insert;
wherein the second component is bonded to the insert by a weld nugget located at a contact point between the second component and the insert, wherein the weld nugget is composed of low carbon steel from the insert and steel from the second component that have been locally melted and solidified to form the weld nugget without use of a filler material therebetween.

18. The assembly of claim 17, wherein the insert includes one or both of (i) one or more raised surface features extending outward from the first insert surface and (ii) one or more lowered surface features extending inward from the first insert surface.

19. The assembly of claim 17, wherein the first component is a differential carrier and the second component is a ring gear.

20. The assembly of claim 19, wherein the differential carrier and the ring gear are operatively connected with each other to form a differential carrier assembly arrangement, and further comprising:
an automotive vehicle having a powertrain, wherein the powertrain includes the differential carrier assembly arrangement.
